(19) United States
(12) Patent Application Publication
(10) Pub. No.: US 2010/0108724 A1
(43) Pub. Date: May 6, 2010

(54) Twist open/twist close Closure

(76) Inventor: Gilbert Buchalter, Millburn, NJ (US)

Correspondence Address: RICHARD R. MUCCINO, 758 SPRINGFIELD AVENUE, SUMMIT, NJ, 07901, US

(21) Appl. No.: 12/261,564

(22) Filed: Oct. 30, 2008

(51) Int. Cl. B67D 3/00

(52) U.S. Cl. 222/521

(57) ABSTRACT

The present invention provides a twist open/twist close closure for a container wherein the finger of the hand that holds the container can open or close the twist open/twist close closure. The configuration of the twist open/twist close closure also permits the user a clear view of where the product in the container can be applied.

### FIELD OF THE INVENTION

The present invention provides a twist open/twist close closure for a container wherein the finger of the hand that holds the container can open or close the twist open/twist close closure. The configuration of the twist open/twist close closure also permits the user a clear view of where the product in the container can be applied.

### BACKGROUND OF THE INVENTION

The prior art discloses dispensing closure caps for containers, which are of the push-pull or threaded screw type, which typically require two hands, one to hold the container and one to push-pull or twist the cap.

U.S. Pat. No. 6,910,607 (Gaiser et al.) discloses a closure for dispensing a product from a container including a cover for a flexible dispensing valve. The cover, which is removably coupled to a base of the closure, includes a central post that extends downwardly from a top portion of the cover. A distal portion of the post contacts the flaps of the dispensing valve to inhibit the flaps from opening. The dispensing valve flaps are part of a valve head that open in response to internal positive pressure within the container from their at-rest, closed position. The post of the cover preferably contacts the flaps at the point of intersection of the slits forming the flaps. An outer circular projection extending downwardly from the top portion may also restrict movement of the valve head. The projection preferably is a ring. The cover prevents inadvertent opening of the valve. Specifically, Gaiser et al. discloses a closure comprising a base fanning an orifice through which the product is capable of passing. The base includes a coupling member extending inwardly toward the orifice for coupling the base to the container. A flexible dispensing valve is secured within the base, the dispensing valve including a valve bead having flaps formed therein that open from an at-rest, sealed position. The dispensing valve flaps are formed by slits formed in the valve head, the slits forming an intersection point thereof. A cover is removably coupled to the base, the cover including a central post extending downwardly from a top portion of the cover and an outer projection disposed concentrically about that central post. A distal portion of the post contacts the flaps at or proximate the intersection point to inhibit the flaps from opening.

U.S. Pat. No. 6,880,730 (Fulwood) discloses a twist-type closure cap for a container, the twist-type closure cap including a cap portion, and a stand portion, the cap portion including a cap body rotatably mounted on a threaded central post having a bore there through with a bottom portion of the post being adapted to be secured to a container such that the container is in communication with the bore such that rotation of the cap body relative to the central post opens and closes the bore, and the stand portion comprising one or more legs, each leg being dependent from the cap body and extending radially outwardly there from, such that in use, the stand portion enables the container to maintain an inverted position while each leg facilitates rotation of the cap body relative to the central post. Fulwood discloses a closure cap comprising a cap portion and a stand portion. The cap portion comprises a cap body rotatably mounted on a threaded central post having a bore there through with a bottom portion of the post secured to the container such that the container is in communication with the bore so that rotation of the cap body relative to the central post opens and closes the bore. The stand portion comprises a leg, being dependent from the cap body and extending radially outwardly there from such that in use the stand portion enables the container to maintain an inverted position while the leg facilitates rotation of the cap body relative to the central post. A degree of rotation of the cap body relative to the threaded central post determines an extent to which the bore is opened.

U.S. Pat. No. 6,702,161 (Adams et al.) discloses a closure for a container having a foil or membrane sealed opening. The closure includes a cap, a spout and a stem. The stem includes a downwardly extending piercing structure adapted for piercing the foil or membrane of the container upon rotation of the spout relative to the cap. Adams et al. discloses a closure having an opening, the closure comprising a cap including a cap top, a container-engaging member, an open sleeve extending upwardly from the cap top, and a stem guide. A spout rotatably engages the sleeve. The spout includes a spout top including an outer spout skirt depending from the spout top and rotatably engaging the sleeve. An inner spout skirt depends from the spout top. A stem includes an outwardly extending spout-engaging member. An outwardly extending cap-engaging member is provided, the spout engaging member engaging the inner spout skirt for helical motion with respect to the inner spout skirt. The cap-engaging member engages the stem guide for axial motion with respect to the sleeve.

U.S. Pat. No. 6,477,743 (Gross et al.) discloses a dispensing closure system for a container that has an opening to the container interior. The dispensing closure system comprises a body for extending from the container at the opening. The body includes (a) a base, (b) a conduit that is reciprocatable relative to the base, and (c) a flexible wall joining the conduit to the base. The conduit includes a discharge aperture, a first seal surface, and a sliding seal bead. A spout is carried on, and rotatable relative to, the body and includes a dispensing orifice and a second seal surface for engaging the first seal surface when the conduit is at a predetermined position relative to the base. A third seal surface continuously engages the conduit sliding seal bead. The body and spout together define a rotary-to-linear motion translation drive system that includes a cam track groove on the spout and a cam follower on the conduit for being received in the cam track groove. Rotation of the spout in one direction moves the conduit in a first direction to a closed position in which the first and second sealing surfaces are in sealing engagement to occlude the spout dispensing orifice. Rotation of the spout in the opposite direction moves the conduit in a second direction opposite from the first direction to an open position in which the conduit first seal surface is spaced from the spout second seal surface to permit flow from the conduit discharge aperture through the spout dispensing orifice. The flexible wall temporarily deforms as the conduit moves between the first and second positions, the flexible wall preventing movement of the conduit in the second direction beyond the open position.

U.S. Pat. No. 6,338,425 (Berge et al. '425) discloses a dispensing closure for a product container including a base positioned on the container and a cap operable on the base between a closed and an open position. The base includes an upstanding plug engageable within an aperture formed in a top platform of the cap to seal the aperture when the cap is moved to closed position on the base. An annular generally U-shaped sealing flange is formed on the aperture and depends below the top platform of the cap. The flange moves into compression engagement with the plug when the cap is in its closed position so as to seal the contents of the container and prevent product and/or carbonated gas leakage there from until the cap is moved to open position. Berge et al. discloses a closure comprising a base adapted to be secured to a mouth of the container for controlled dispensing of a product from the container. The base includes a top panel and a side wall depending peripherally from that top panel, a central post projecting axially upward from that top panel centrally in radially inwardly spaced relation to that side wall, that post defining a product flow passage vertically there through and opening through that top panel, that product flow passage having an open upper end vertically remote from that top panel. A sealing plug is centrally positioned relative to that product flow passage at that upper end and arranged to allow for product movement past that plug. Means for mounting that plug to that product flow passage are provided with minimal restriction of the passage outward of the plug. A cap includes a peripheral wall received over that post. That cap has a top platform closing off that peripheral wall. A central aperture is formed in that top platform and is aligned with that plug. That cap is telescopically adjustable on that post between a lower closed position with that plug engaged in that aperture and an upper open position with that plug spaced below that aperture to allow product discharge through that aperture. An annular generally to U-shaped sealing flange is formed on that aperture. That flange includes a first leg and a second leg formed integral with each other. The legs extend substantially below the circumferential periphery of the aperture and below the top platform of the cap.

U.S. Pat. No. 6,299,038 (Schmeisser et al.) discloses a dispensing closure of three separately formed interlocking components. The closure includes a container mountable base with a central post mounting a spout for vertical movement thereon between a closed position with a post mounted plug sealing within a spout aperture, and a second open position with the plug remote from the aperture, movement of the spout relative to the post and plug being achieved by a sleeve rotatably mounted on the base and engaged with the spout for rotation of the spout with the sleeve and, through cooperating engagement of the spout with the post, for longitudinal adjustment of the spout relative to the post. Schmeisser et al. discloses a closure comprising a base adapted to be secured to the mouth of the container for a controlled dispensing of a product from the container. The base includes a body having a top panel and a side wall depending peripherally from the top panel, a central post projecting axially upward from the top panel centrally thereof in radially inwardly spaced relation to the body side wall. The post has a cylindrical side wall defining a product flow passage vertically there through and opening through the top panel. The post passage has an open upper end vertically remote from the top panel, a sealing plug centrally positioned relative to the passage at the upper end and radially inward of the cylindrical wall of the post to allow for product movement past the plug. A means is provided for mounting the plug to the post wall with minimal restriction of the passage outward of the plug. A spout includes a cylindrical side wall telescopically received over the post, the spout having a non-circular top overlying the post and the passage there through. The spout top extends radially outward from the spout wall at least partially thereabout. The top has a central aperture there through aligned with the plug for discharge of a product from the passage through the aperture. The spout is telescopically adjustable on the post between a lower closed position with the plug engaged in and sealing the aperture, and an upper open position with the plug spaced below the aperture to allow product discharge through the aperture. Means are provided for telescopically adjusting the spout relative to the plug, the means for telescopically adjusting the spout including a manual control member outward of the spout. The control member has a lower portion proximate the base body top panel, means for retaining the lower portion on the top panel for rotation relative thereto about the spout. The control member has an upper portion defining an opening configured to conform to the non-circular top and receive the top therein, whereby rotation of the control member will effect a corresponding rotation of the top and the spout, and cooperating means on the spout and the base post for telescopically moving the spout on the post in response to rotation of the spout relative to the post.

U.S. Pat. No. 6,135,318 (Valley) discloses a closure for dispensing contents within a dispenser comprising a post projecting upwardly from a base and a closure cap. The post has an upper solid portion, including a notch to facilitate multiple dispensing rates of the closure, connecting segments between the upper and lower portions and a cam follower. In a first dispensing position, the contents are dispensed only out of the notch. A closure cap is rotatably mounted for movement along at least a portion of the post. The post extends beyond the top of the cap in the closed position. The cap has a cam for movement of the cap with respect to the cam follower to facilitate rotation of the cap along the post. In a second dispensing position of the closure, the contents are dispensed through an upper orifice of the cover cap. Valley discloses a closure comprising a post projecting substantially upwardly from a base. The post comprises an upper solid portion, a lower portion having an aperture there through, a cam follower, and a closure cap having an upper and a lower orifice. The cap is rotatably mounted for movement along a portion of the post, the cap comprising a cam for facilitating movement of the cap with respect to the cam follower to facilitate rotation of the cap along the post.

U.S. Pat. No. 5,505,346 (Smith) discloses a thumb actuated flexible tube and closure system comprising a flexible plastic tube having a finish for dispensing a product when the tube is in an inverted position. The system comprises a finish having an integral transverse wall, an integral post extending upwardly from the transverse wall and an integral cylindrical wall extending upwardly from the transverse wall. The transverse wall has an opening there through, an inner closure having a base wall and integral spaced inner and outer walls defining an annular space for receiving the cylindrical wall of the finish of the plastic tube. One of the spaced inner and outer walls has thread means thereon for rotatably engaging the cylindrical wall of the finish. The base wall of the inner closure has a portion sealingly engaging the post on the finish such the rotation of the inner closure moves the sealing portion into and out of engagement with the post. An overcap closure has a base wall with an opening aligned with the sealing portion of the closure. The overcap and the finish have interengaging means to hold the overcap against rotational movement. The overcap includes a peripheral wall having an opening therein. A finger engaging portion on the inner closure extends through the opening in the overcap closure and is adapted to be engaged by a thumb of the user as the plastic tube is held in an inverted position to rotate the inner closure and move the inner closure into and out of sealing position with the post on the finish.

U.S. Pat. No. 5,431,305 (Kamininski) discloses a liquid dispensing package including a container whose finish has an opposed pair of slots extending vertically from a free end thereof. A nozzle element with a dispensing passage extends there through and is positioned within the finish and has an opposed pair of pins, which extend into and through the slots of the finish to permit the nozzle element to translate, but not rotate, with respect to the finish. The translation is between a sealed, non-dispensing position and an unsealed, dispensing position. A cap element is rotatably affixed to the finish and has an opening in a top central panel, which is aligned with the dispensing passage of the nozzle element. A skirt of the cap element has part helical grooves on its inside surface, and these grooves receive the free ends of the pins of the nozzle element. Rotation of the cap element results in translation of the nozzle element. The opening of the central panel of the cap element has a frangible portion which is ruptured by contact with a boss at a free end of the nozzle element upon the first opening of the package to provide the package with tamper evident opening characteristics. Kamininski discloses a liquid dispensing package comprising a container having a finish portion with a slot opening in the finish portion. The slot opens extending generally parallel to a longitudinal axis of the finish portion. A nozzle element is positioned within the finish portion. The nozzle element has a passage means extending there through to permit the dispensing of liquid within the container through the nozzle element. The nozzle element further has a pin extending there from into and through the slot opening in the finish portion. The nozzle element is non-rotatable with respect to the finish portion and is translatable with respect to the finish portion along the longitudinal axis thereof between a first position and a second position. A cap element has a top panel portion and an annular skirt portion extending perpendicularly from the top panel portion, the top panel portion having an opening therein. The cap element is rotatable with respect to the finish portion of the container with a substantial portion of the annular skirt portion surrounding a portion of the finish portion. The opening in the top panel portion is in alignment with the passage means of the nozzle element. The annular skirt portion has an inclined groove on an inside surface, the inclined groove receiving a free end portion of the pin, whereby rotation of the cap element with respect to the container in a first rotational direction will translate the nozzle element in a first linear direction along the longitudinal axis of the finish portion and rotation of the cap element with respect to the container in an opposed rotational direction will translate the nozzle element in an opposed linear direction along the longitudinal axis of the finish portion.

U.S. Pat. No. 4,967,941 (Beck) discloses a closure cap for dispensing contents of a container. The cap comprises a central post having a top surface and a substantially cylindrical imperforate peripheral wall with an opening to the top surface for metering the contents to be dispensed. A cap body reciprocally is mounted on the central post and has an inner periphery which cooperates with the post peripheral wall to form a variable opening between the cap body inner periphery and the post peripheral wall to provide a closure position, a fully open position, and a plurality of dispensing positions for dispensing the contents of the container at a plurality of different rates as the cap body is moved on the post away from the closure position toward the fully open position. Cooperative detent means are provided between the post and cap body for providing a positive indication that can be felt by a user during movement of the cap body, which indicates when the cap body has reached the closure position or the fully open position, respectively.

U.S. Pat. No. 4,065,037 (Haller) discloses a two-piece, non-spurting dispensing closure for a container of the type having a finish. The closure comprises a shell and a tip. The shell has a top portion and an annular skirt for surrounding the container finish. Means for attaching the skirt to the container finish are provided. An upstanding cylindrical chimney is located centrally of the top portion of the shell. The chimney has a dispensing passageway extending axially there through and through the top portion of the shell. A cylindrical plug and means for supporting the plug axially are provided at the upper end of the chimney so as to extend there above. A pair of upstanding diametrically opposed posts are located on the top portion of the shell to either side of and spaced from the chimney, each of the posts having a thread-receiving groove opening away from the chimney. The tip comprises a top portion and a downwardly depending skirt portion. The top portion of the tip has a dispensing opening located centrally thereof and passes there through. The tip has a cylindrical wall surrounding the dispensing opening and depends downwardly from the top portion thereof. The cylindrical wall surrounds the shell chimney and has an inside diameter so sized as to be rotatable about and axially shiftable with respect to the shell chimney. A pair of diametrically opposed inclined planes are provided to either side of the cylindrical wall, each of the inclined planes contacting an upper edge of one of the shell posts. A pair of thread segments are located on diametrically opposed inside surface portions of the tip skirt. Each of the thread segments are parallel and are spaced from one of the inclined planes and are engaged in the groove of one of the shell posts. When the tip is twisted relative to the shell in one direction each of the shell posts cooperates with its respective tip thread segment and inclined plane to elevate the tip with respect to the shell from a retracted closed position, wherein the plug is located in and closes the tip dispensing opening to an extended open position wherein the plug is withdrawn from the tip dispensing opening and when the tip is twisted relative to the shell in an opposite direction each of the posts cooperates with its respective thread segment and inclined plane to lower the tip with respect to the shell from the extended open position to the retracted closed position.

U.S. Pat. No. Des. 381,907 (King) is a design patent showing 8 Figures of container closures.

United States patent application publication no. 2008/0124432 (MA) discloses a closure for a container having an opening including a base cap and an overcap that forms a chamber adjacent to the opening which is sealed from the contents of the container by a frangible membrane having an inclined line of weakness and by a hinge member having a pocket extending downward adjacent lower and upper terminuses of the line of weakness. The overcap includes a cutting member received within the pocket that severs the line of weakness upon substantial rotation of the overcap with respect to the base cap. A pushing member may cooperate with a cam member to deflect open the membrane upon severance. The pocket may include a stop for the cutting member. The base cap may include a cylindrical structure having an upwardly inwardly projection member to form a seal with a thickened upper portion of the overcap skirt to protect against penetration into the chamber. MA discloses a container having a base cap including a cylindrical structure having an annular groove, an overcap having a locking structure rotatably received within the groove to axially fix the overcap with respect to the base cap. The base cap includes an outer skirt having a container engaging structure, a cylindrical well defining a chamber for containing and supporting a consumable or other item located therein. A frangible membrane is connected to the well along an inclined line of weakness and by a hinge member within the well. The hinge member has a pocket extending downward adjacent lower and upper terminuses of the line of weakness. The base cap cylindrical structure has an upwardly inwardly directed projection at an upper surface thereof defining a minimum diameter. The overcap includes a body having a gripping structure, an inner skirt received within and rotatably positioned relative to the well, and a cutting member depending from a lower end of the inner skirt substantially received within the pocket such the cutting member extends below the lower terminus when the base cap is assembled to the overcap, whereby the cutting member severs the line of weakness upon substantial rotation of the overcap with respect to the base cap. The overcap inner skirt has an upper and lower portion. The upper portion is thickened to have an increased outside diameter as compared to the lower portion, and the increased outer diameter forms a seal with the minimum diameter of the cylindrical structure projection against penetration into the well.

United States patent application publication no. 2006/0196894 (Lindsay) discloses a container closure assembly having an occlusion region providing a first component. The first component is adapted for a closing engagement with a complementary container, and has a liquid passageway to be open from the container to an outlet below. Part of the occlusion region, as a second component, is a spout or top with a dispensing outlet capable of being occluded by the occlusion region to provide a liquid tight environment from an engaged liquid bearing container unless the second component rises from its dispensing outlet occluding condition. A third component controls the rise and fall of the second component by rotation relative to the occlusion region. Lindsay discloses a dispensing closure assembly suitable to be engaged to a complementary container. The assembly comprises a first molded component adapted to engage an outlet of a complementary container and to provide an outlet from which any liquid content of such a container can egress. The first molded component includes a closure portion above the outlet. A second molded component is about part of the first component and has a dispensing outlet capable of being closed by the closure portion of the first component. A third molded component is held captive by the first component but is rotatable relative thereto. The assembly is characterized in the rotation of the third component and relative to the first component can cause movement of the second component relative to the first component to effect opening (i.e. displacement of the closure portion from the dispensing outlet of the second component, or vice versa) and/or can cause movement of the second component relative to the first component to effect closure (i.e. of the dispensing opening with the closure portion).

United States patent application publication no. 2002/0113096 (Valley III) discloses a closure assembly for a container containing substantially flowable contents. The assembly comprises a closure cap, a sealing member, and a small orifice between the cap and the sealing member, which remains slightly open when the closure is in a closed position.

United States patent application publication no. 2002/0096532 (Berge et al. '532) discloses a two piece hinged closure for a container. The closure includes a base installed on the container and a hinged cap positioned on the base. The hinge of the cap includes a caming tab and the base includes a caming surface against which the tab moves when the cap is moved between its closed and open positions to retain the cap in the open position. Berge et al. discloses a closure comprising a cap including a container closing portion and a skirt adapted to be positioned adjacent to the mouth. A hinge is connected to the skirt of the container closing portion. A hinge abutment surface is positioned upon the mouth. The hinge includes a cam tab with a free edge engaged against the abutment surface. A hinge strap is located adjacent to the cam tab, whereby movement of the cap between a first closed position on the mouth and a second open position causes the hinge strap to stretch and the cam tab to move along the hinge abutment surface and retain the cap in the open position.

PCT patent application WO 2006/079883 (Wazel) discloses a closure, which comprises a locking ring and a locking cylinder pressable into a stepped bore hole, thereby ensuring an optimal tightness. The closure is operable by rotating a lid. During the operation, a pressurized beverage penetrates into an expansion chamber prior to coming out through an opening embodied in the lid bottom.

PCT patent application WO 02/14180 (Klein) discloses a beverage holder including a tubular housing with a chamber to hold a beverage can, a removable lid that seals to the housing, can rim, and a variable flow, drink through, twist valve that seals to the lid. In such a configuration, a can of a beverage may be maintained in a manner that the carbonation does not escape from the beverage. Klein discloses a beverage holder comprising a twist valve, a lid, and a housing. The housing has a chamber for containing a beverage. The lid has an opening that communicates with a vent passage that is defined in that the twist valve; the housing and the lid having first complementary elements that rotatably interconnect the lid and the housing. The twist valve and the lid have second complementary elements that rotatably interconnect the twist valve and the lid. The housing and the lid carry third complementary elements to interface with and actuate a first annular compression seal component the engages when the lid and the housing are interconnected to form a first pressure-proof seal between the lid and the housing; the twist valve and the lid carrying fourth complementary elements to interface with and actuate a second annular compression seal component the engages when the twist valve and the lid are interconnected to form a second pressure-proof seal between the a vent passage and the opening in the lid. The second annular compression seal component is engagable, adjustable, and disengagable by means of complimentary interconnected elements of the twist valve and the lid. The second annular compression seal component, when disengaged, allows a liquid flow through the opening in the lid and then through the vent passages in the twist valve. A flow rate of the liquid flow around the second annular seal component is adjustable by means of the first complimentary interconnected elements of the twist valve and the lid. The twist valve and the lid carrying fifth complementary elements to interface with and engage third annular seal component when the twist valve and the lid are interconnected to form a generally leak-proof seal. The third annular seal component is constantly engaged when the twist valve and the lid are interconnected. The twist valve includes a drinking orifice element located above the elements to interconnect to the lid.

Therefore, there is a need to develop new dispensing closures for containers of the threaded screw type wherein the finger of the hand that holds the container can open or close the twist open/twist close closure.

### In The Figures

FIG. 1 depicts the twist open/twist close closure for a container in a closed position.

FIG. 2 depicts the twist open/twist close closure for a container in an open position.

FIG. 3 depicts the central post in the twist open/twist close closure

FIG. 4 depicts the cap in the twist open/twist close closure.

### SUMMARY OF THE INVENTION

The present invention provides a twist open/twist close closure for dispensing extrudable contents within a container comprising:

a central post comprising:

abase;

upwardly extending portions from the base; and

an aperture extending from the base through the upwardly extending portions; and

a cap comprising:

a base extending outwardly from the bottom of the cap;

a wedge extending outwardly from the cap; and

an aperture extending from the base through the top of the cap;

wherein the cap is rotatably mounted for movement along a portion of the central post and the wedge extending outwardly from the cap facilitates rotation of the cap along the central post such that a finger of a hand that holds the container attached to the twist open/twist close closure can open or close the container.

The present invention also provides a twist open/twist close closure for dispensing extrudable contents within a container comprising:

a central post comprising:

abase;

substantially cylindrical upwardly extending portions from the base with connecting segments between the upwardly extending portions;

spiral twist guides projecting slightly outwardly from an upwardly extending portion in the central post; and

an aperture extending from the base through the upwardly extending portions; and

a cap comprising:

a base extending outwardly from the bottom of the cap;

a wedge extending outwardly from the cap;

spiral twist guides projecting slightly inwardly in the cap ; and

an aperture extending from the base through the top of the cap;

wherein the cap is rotatably mounted to the central post by spiral twist guides projecting slightly outwardly from an upwardly extending portion in the central post to reciprocally engage corresponding spiral twist guides projecting slightly inwardly in the cap and the wedge extending outwardly from the cap facilitates rotation of the cap along the central post such that a finger of a hand that holds the container attached to the twist open/twist close closure can open or close the container.

### DETAILED DESCRIPTION OF THE INVENTION

The present invention provides a twist open/twist close closure for a container wherein the finger of the hand that holds the container can open or close the twist open/twist close closure. The configuration of the twist open/twist close closure also permits the user a clear view of the where the product in the container can be applied.

In a preferred embodiment, the present invention provides a twist open/twist close closure for dispensing extrudable contents within a container comprising: (A) a central post comprising: (a) a base; (b) upwardly extending portions from the base; and (c) an aperture extending from the base through the upwardly extending portions; and (B) a cap comprising: (a) a base extending outwardly from the bottom of the cap; (b) a wedge extending outwardly from the cap; and (c) an aperture extending from the base through the top of the cap; wherein the cap is rotatably mounted for movement along a portion of the central post and the wedge extending outwardly from the cap facilitates rotation of the cap along the central post such that a finger of a hand that holds the container attached to the twist open/twist close closure can open or close the container.

The invention will be better understood from the following detailed description of the preferred embodiments taken in conjunction with the Figures, in which like elements are represented by like referenced numerals.

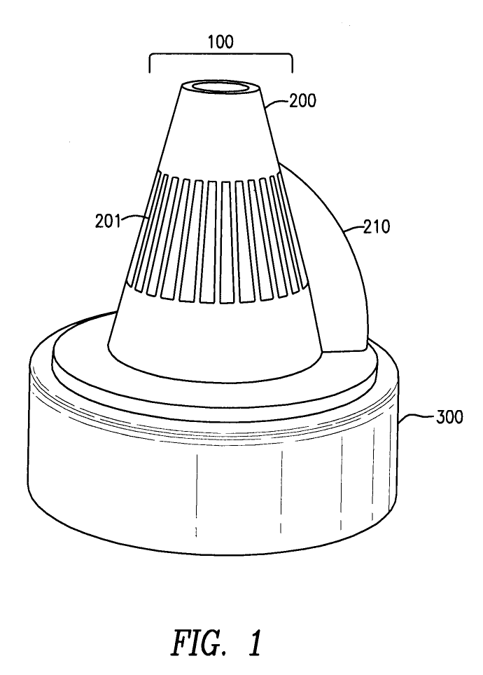

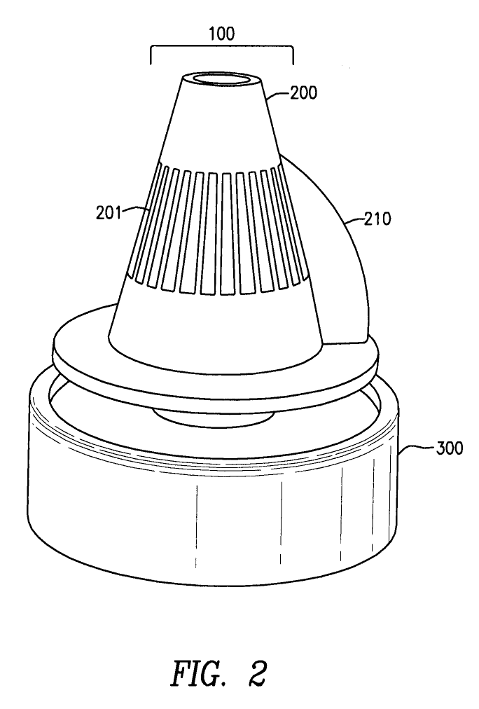

In FIGS. 1 and 2, a twist open/twist close closure for a container, wherein the finger of the hand that holds the container can open or close the twist open/twist close closure, in accordance with the present invention, is depicted generally as 100 and constructed in accordance with a preferred embodiment of the present invention. FIG. 1 depicts twist open/twist close closure 100 for a container in a closed position. FIG. 2 depicts twist open/twist close closure 100 for a container in an open position. The containers may be virtually any type of container, e.g., for glue, caulking, etc.

In FIGS. 1 and 2, twist open/twist close closure 100 comprises a cap 200 and a central post 300. The cap 200 is reciprocally mounted on the central post 300. Cap 200 has a projecting wedge 210. Twist open/twist close closure 100 may be moved from the closed position as shown in FIG. 1 by rotating projecting wedge 210 clockwise or counterclockwise on central post 300 to an opened position as shown in FIG. 2. Rotation of projecting wedge 210 may be adjusted to suit the particularly use of the extrudable contents in the container, preferably the rotation is an eighth of a turn. Projecting wedge 210 provides means for the finger of the hand that holds the container to open or close the twist open/twist close closure 100. Optionally, means for improving gripping 201 may be included.

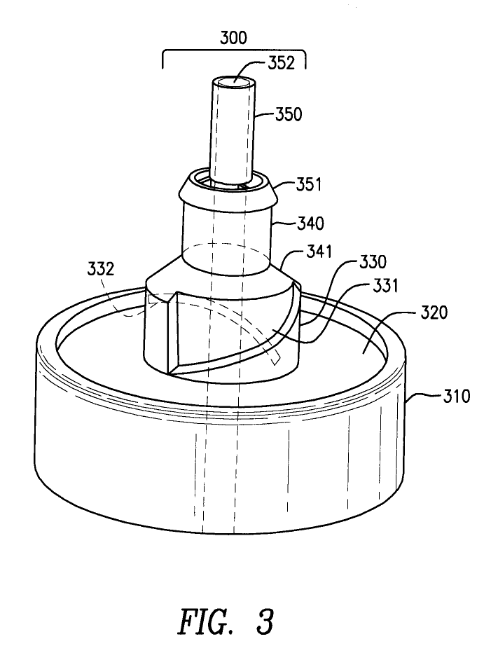

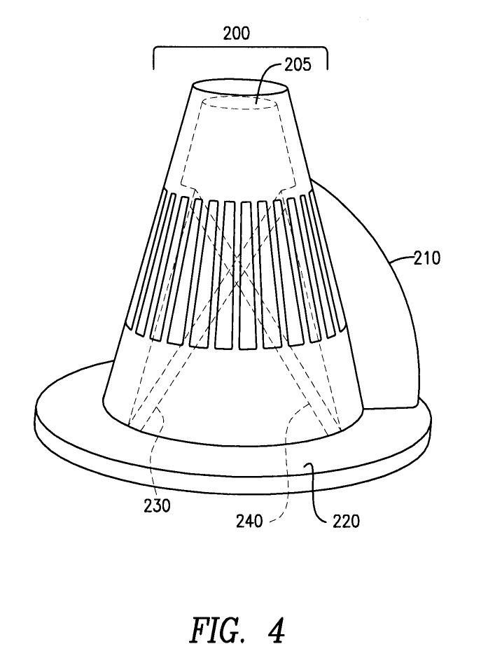

FIG. 3 depicts central post 300. Central post 300 has a base 310 with a lip 320, in which cap 200 sits when the twist open/twist close closure is in the closed position. Base 310 has three upwardly extending portions, 330, 340, and 350, preferably substantially cylindrical, and preferably with connecting segments 331, 341, and 351, between the upwardly extending cylinder portions. Cylinder portion 330 has spiral twist guides, 331 and 332, which project slightly outwardly from cylinder portion 330 to reciprocally engage and guide corresponding spiral twist guides, 230 and 240 (FIG. 4), in cap 200. Twist open/twist close closure 100 may be moved from the closed position by rotating cap 200 counterclockwise on central post 300 to an opened position by movement of projecting wedge 210 in cap 200 to open or close the twist open/twist close closure 100 by movement of cylinder portion 330 on spiral twist guides, 331 and 332, which reciprocally engage and guide corresponding spiral twist guides, 220 and 230 in cap 200. Central post aperture 352 begins at bottom of base 310 and extends to the top passing through through all three cylinder portions, 330, 340, and 350. Central post aperture 352 allows flow of the contents of the container to which twist open/twist close closure 100 is attached.

FIG. 4 depicts cap 200 shown in FIGS. 1 and 2 in more detail. Cap 200 is conical in shape with an outwardly extending bottom 220, which sits inside lip 320 of the central post when in the closed position. Projecting wedge 210 extends outwardly from cap 200 and extends to bottom 220. Projecting wedge 210 provides means for the finger of the hand that holds the container to open or close the twist open/twist close closure 100 by clockwise or counterclockwise movement of projecting wedge 210. Cap 200 has spiral twist guides, 230 and 240, which project slightly inwardly from cap 200 to reciprocally engage and guide corresponding spiral twist guides, 331 and 332 (FIG. 3), in central post 300. Cap aperture 250 extends from the base to the top of cap 200 to facilitate insertion of central post 300 and allow flow of the contents of the container to which twist open/twist close closure 100 is attached.

In another preferred embodiment, the present invention also provides a twist open/twist close closure for dispensing extrudable contents within a container comprising: (A) a central post comprising: (a) a base; (b) substantially cylindrical upwardly extending portions from the base with connecting segments between the upwardly extending portions; (c) spiral twist guides projecting slightly outwardly from an upwardly extending portion in the central post; and (d) an aperture extending from the base through the upwardly extending portions; and (B) a cap comprising: (a) a base extending outwardly from the bottom of the cap; (b) a wedge extending outwardly from the cap; (c) spiral twist guides projecting slightly inwardly in the cap; and (d) an aperture extending from the base through the top of the cap; wherein the cap is rotatably mounted to the central post by spiral twist guides projecting slightly outwardly from an upwardly extending portion in the central post to reciprocally engage corresponding spiral twist guides projecting slightly inwardly in the cap and the wedge extending outwardly from the cap facilitates rotation of the cap along the central post such that a finger of a hand that holds the container attached to the twist open/twist close closure can open or close the container.

While a number of embodiments of this invention have been represented, it is apparent that the basic construction can be altered to provide other embodiments that utilize the invention without departing from the spirit and scope of the invention. All such modifications and variations are intended to be included within the scope of the invention as defined in the appended claims rather than the specific embodiments that have been presented by way of example.

1. A twist open/twist close closure for dispensing extrudable contents within a container comprising:
(A) a central post comprising:
(a) a base;
(b) upwardly extending portions from the base; and
(c) an aperture extending from the base through the upwardly extending portions; and
(B) a cap comprising:
(a) a base extending outwardly from the bottom of the cap;
(b) a wedge extending outwardly from the cap; and
(c) an aperture extending from the base through the top of the cap;
wherein the cap is rotatably mounted for movement along a portion of the central post and the wedge extending outwardly from the cap facilitates rotation of the cap along the central post such that a finger of a hand that holds the container attached to the twist open/twist close closure can open or close the container.

2. The closure according to claim 1, wherein the cap is rotatably mounted to the central post by spiral twist guides projecting slightly outwardly from an upwardly extending portion in the central post to reciprocally engage corresponding spiral twist guides projecting slightly inwardly in the cap.

3. The closure according to claim 1, wherein the wedge extending outwardly from the cap provides a clear view of the extrudable contents within the container.

4. The closure according to claim 1, wherein the upwardly extending portions are substantially cylindrical.

5. The closure according to claim 1, further comprising connecting segments between the upwardly extending portions.

6. The closure according to claim 1, wherein the cap has means for improved gripping.

7. The closure according to claim 1, wherein the cap is rotated counterclockwise to open and clockwise to close.

8. The closure according to claim 1, wherein the post extends beyond top of the cap in the closed position.

9. A twist open/twist close closure for dispensing extrudable contents within a container comprising:
(A) a central post comprising:
(a) a base;
(b) substantially cylindrical upwardly extending portions from the base with connecting segments between the upwardly extending portions;
(c) spiral twist guides projecting slightly outwardly from an upwardly extending portion in the central post; and
(d) an aperture extending from the base through the upwardly extending portions; and
(B) a cap comprising:
(a) a base extending outwardly from the bottom of the cap;
(b) a wedge extending outwardly from the cap;
(c) spiral twist guides projecting slightly inwardly in the cap ; and
(d) an aperture extending from the base through the top of the cap;
wherein the cap is rotatably mounted to the central post by spiral twist guides projecting slightly outwardly from an upwardly extending portion in the central post to reciprocally engage corresponding spiral twist guides projecting slightly inwardly in the cap and the wedge extending outwardly from the cap facilitates rotation of the cap along the central post such that a finger of a hand that holds the container attached to the twist open/twist close closure can open or close the container.
